(19) United States
(12) Patent Application Publication
(10) Pub. No.: US 2014/0000781 A1
(43) Pub. Date: Jan. 2, 2014

(54) SINGLE-PLY, ROLL-FED EXPANDED CONTENT LABEL APPLICATION DEVICE AND METHOD

(71) Applicant: Joseph D. Franko, JR., Hopkins, MN (US)

(72) Inventor: Joseph D. Franko, JR., Hopkins, MN (US)

(21) Appl. No.: 13/884,476

(22) PCT Filed: Oct. 31, 2011
(86) PCT No.: PCT/US11/58600

§ 371 Date: May 9, 2013

Related U.S. Application Data
(60) Provisional application No. 61/412,714, filed on Nov. 11, 2010.

(51) Int. Cl. B65C 9/18

(52) U.S. Cl. CPC B65C 9/18
USPC 156/60; 118/255; 118/300; 118/301

(57) ABSTRACT

A device for applying adhesive material to single-ply, roll-fed expanded content labels could include a leading edge adhesive material application pad, a trailing edge adhesive material application pad, and an intermediate adhesive material application pad. A method for applying single-ply, roll-fed expanded content labels to objects to be labeled could include a device for applying adhesive material to single-ply, roll-fed expanded content labels.

### TECHNICAL FIELD

This disclosure relates generally to label application devices and methods. More particularly, this disclosure relates to devices and methods for applying single-ply, roll-fed expanded content labels to objects to be labeled.

### BACKGROUND

In the printing arts, and in particular in the printed label art for labeling and decorating objects, there exists a continual demand for labels and decorations which not only appeal to consumers, but also bear ever increasing amounts of information. For example, labels for identification of health care and pharmaceutical products are often required by governmental regulations to describe in painstaking detail their compositions and ingredients. As new food and drug laws are passed, regulations require the inclusion of increasing amounts of label information. As another example, labels for identification of agricultural and industrial products are similarly required by governmental regulations to describe their compositions and ingredients by way of, e.g., “material safety data sheets” and the like. To address these needs, labels have been proposed that are typically constructed from a plurality of label plies (a “multi-ply” construction) and may be repeatedly manipulated by a consumer or end user to open and reseal in “booklet” fashion. Also, so-called “wrap” labels have been proposed that are typically constructed from a single label ply and are dimensioned to have lengths that are, e.g., 10-100% longer than circumferences of containers to be labeled. Such “wrap” labels may also function in “booklet” fashion by opening or accessing an outermost portion of the label that is wrapped over an innermost portion. Further, other labels have been proposed that incorporate designated areas such as cut lines or scores and the like with graphics indicating, e.g., “cut here” or “tear here”. When so opened or accessed, such purposefully destructible labels are typically not suited for resale or reuse.

Irrespective of multi-ply, “wrap”, or “destructible” constructions, in the labeling arts such labels have also been variously referred to as “extended text” labels, “expanded content” labels, and “booklet” labels (collectively referred to, throughout this disclosure, as “expanded content” labels).

Aside from expanded content labels generally, a label type that has gained popularity is a so-called “roll-fed” label. A roll-fed label commonly utilizes a continuous label substrate or ply comprising paper, or a clear or opaque film such as polypropylene, or a combination of paper and film. In such an individual label, in its final state, the label ply is usually rectangular, as defined by a desired label width associated with a widthwise dimension and a desired label length associated with a lengthwise dimension (transverse to the widthwise dimension). The label ply has opposing first and second ends, along with front and back surfaces. Desired graphics are typically printed on the front surface of the label ply, and may also be printed on the back surface. In application of a roll-fed label to an object to be labeled, e.g., a cylindrical container, a widthwise portion of the back surface of the label ply at the first end thereof is adhered to the container by means of an adhesive material at point of application from labeling equipment. The ply, having been adhesively secured to the container at the first end, is then placed in circular fashion around the container and adhesively secured at the second end of the ply—often closely adjacent to or just overlapping the first end. Unlike the aforementioned “wrap” labels, a length of a typical roll-fed label ply is usually chosen to approximate a circumference of the container to minimize wasteful overlapping of the opposing ends of the label ply that is applied to the container. The application of traditional roll-fed labels to containers may be carried out by any suitable roll-fed label application machines such as those available from, e.g., Krones A.G. of Regensburg, Del., and B&H Labeling Systems of Ceres, Calif., US. Traditional roll-fed labels are typically produced without any adhesive material on the back surface of the label ply, and are provided to customers in roll form as a web of labels. At a point of application of roll-fed labels, a web of labels in roll form is typically introduced to a customer's label application machine which cuts the web into individual labels and applies them to objects to be labeled (e.g., containers). Any adhesive material used to apply the labels to the objects is supplied by the label application machine at the point of application and is generally applied to adhere the leading and trailing edge portions of the labels.

Although various expanded content labels and roll-fed labels have been commercially successful, a need remains for a single-ply, roll-fed expanded content label that may be manipulated by a consumer or end user to open and reseal and thereby provide access to additional information, among other features. A need also remains for a device and method for applying single-ply, roll-fed expanded content labels to objects to be labeled.

### SUMMARY

This disclosure describes novel single-ply, roll-fed expanded content labels. This disclosure also describes novel devices and methods for applying single-ply, roll-fed expanded content labels to objects to be labeled.

In one aspect, a single-ply, roll-fed expanded content label could include a label ply. The label ply could, in turn, include a base material that could optionally include printed graphics on a top side and a bottom side thereof. A clear laminate material could be adhesively joined to the base material by an adhesive material; and a release material could be selectively deposited on a bottom side of the base material. The label ply could also include at least one break path.

In another aspect, a device for applying adhesive material to single-ply, roll-fed expanded content labels could include a vacuum drum. The vacuum drum could, in turn, include a leading edge adhesive material application pad, a trailing edge adhesive material application pad, and an intermediate adhesive material application pad.

In yet another aspect, a method for applying single-ply, roll-fed expanded content labels to objects to be labeled could include a device for applying adhesive material to single-ply, roll-fed expanded content labels.

### BRIEF DESCRIPTION OF THE DRAWINGS

FIG. 1 is a top view illustration of an example of a portion of a label web for single-ply, roll-fed expanded content labels.

FIG. 1a is a cross-sectional illustration of the example of a portion of a label web for single-ply, roll-fed expanded content labels, taken along line a-a in FIG. 1.

FIG. 1b is a cross-sectional illustration of the example of a portion of a label web for single-ply, roll-fed expanded content labels, taken along line b-b in FIG. 1.

FIG. 2 is a top view illustration of an example of a single-ply, roll-fed expanded content label cut from the web of FIG. 1.

FIG. 3 is an illustration of an example of a device for applying adhesive material to single-ply, roll-fed expanded content labels.

FIG. 4 is a schematic diagram of an example of a method for applying single-ply, roll-fed expanded content labels to objects to be labeled, utilizing the example of a device shown in FIG. 3.

FIG. 4a is an illustration of the example of a single-ply, roll-fed expanded content label of FIG. 2, with the example of a device shown in FIG. 3.

FIG. 5 is a top view illustration of the example of a single-ply, roll-fed expanded content label of FIG. 2, after being output from the example of the method for applying single-ply, roll-fed expanded content labels to objects to be labeled shown in FIG. 4.

FIG. 6 is an illustration of another example of a device for applying adhesive material to single-ply, roll-fed expanded content labels to objects to be labeled.

FIG. 7 is an illustration of the example of a single-ply, roll-fed expanded content label of FIG. 5, being applied to a container.

FIG. 8 is an illustration of the example of a single-ply, roll-fed expanded content label of FIG. 7, after having been applied to a container and depicting an opened or accessed condition.

FIG. 9 is a top view illustration of another example of a portion of a label web for single-ply, roll-fed expanded content labels.

FIG. 9a is a cross-sectional illustration of the example of a portion of a label web for single-ply, roll-fed expanded content labels, taken along line a-a in FIG. 9.

FIG. 9b is a cross-sectional illustration of the example of a portion of a label web for single-ply, roll-fed expanded content labels, taken along line b-b in FIG. 9.

FIG. 10 is a top view illustration of another example of a single-ply, roll-fed expanded content label, cut from the web of FIG. 9.

FIG. 11 is a schematic diagram of an example of another method for applying single-ply, roll-fed expanded content labels to objects to be labeled.

FIG. 12 is an illustration of another example of a device for applying adhesive material to single-ply, roll-fed expanded content labels, utilized in the example of a method shown in FIG. 11.

### DETAILED DESCRIPTION

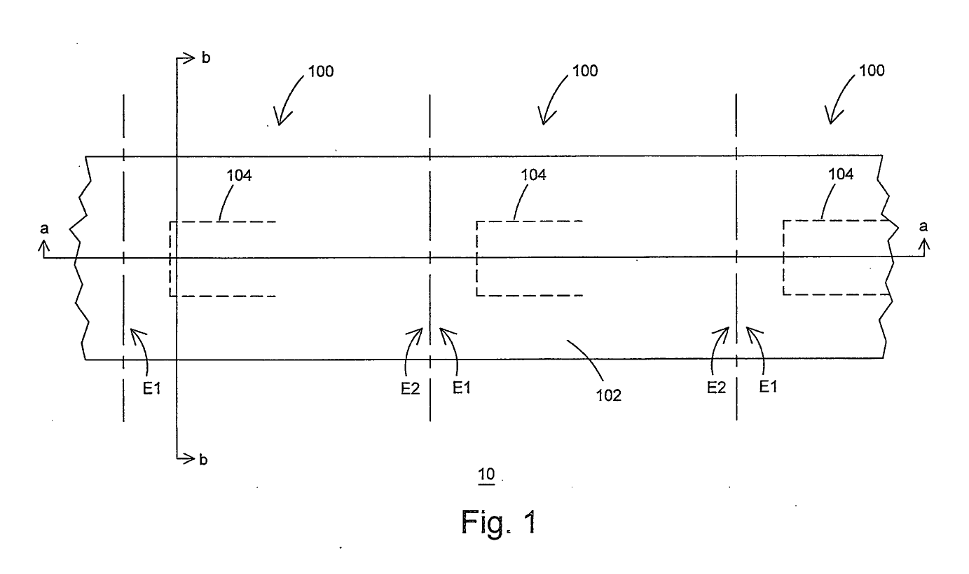

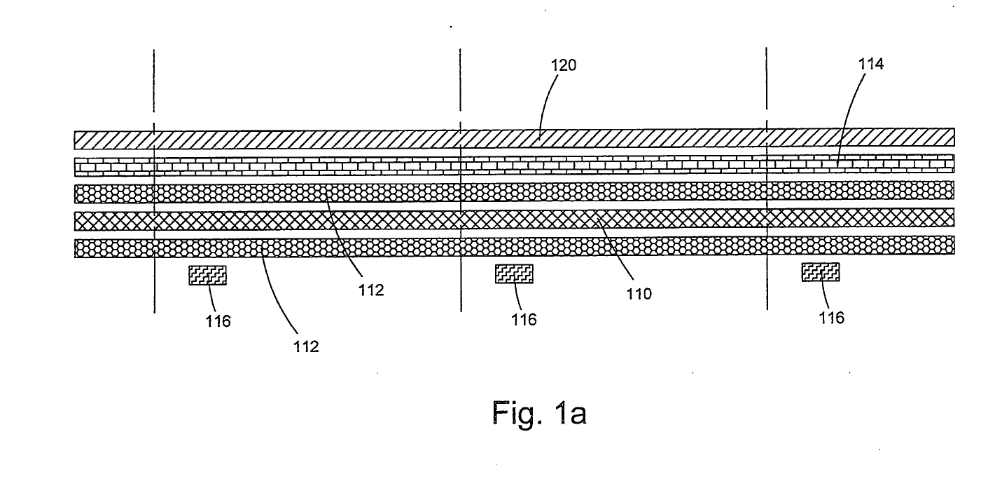

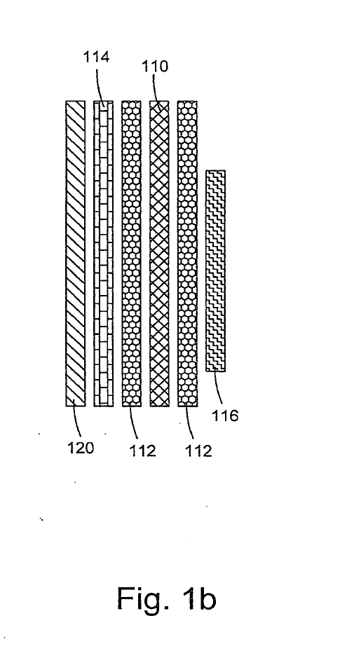

One example of a portion of a label web 10 for single-ply, roll-fed expanded content labels 100 is illustrated in FIGS. 1, 1a, and 1b. Therein, label web 10, comprising individual labels 100, could include a label ply 102.

It is to be noted in general that a single-ply, roll-fed expanded content label, for application to an object to be labeled utilizing separately supplied adhesive material with a roll-fed label application machine, could include a label ply having a first lengthwise dimension, a first widthwise dimension, a front surface that could be capable of bearing graphic images and coatings, and an adhesive-free back surface in its construction, before point of application, that could also be capable of bearing graphic images and coatings and could be capable of being adhesively coupled to an object to be labeled using separately supplied adhesive material at point of application. Specifically, when manufactured and prior to being applied to an object of interest to be labeled, the back surface of the label ply is free of adhesive material. In this state, it can then be supplied as a continuous web in roll form to a roll-fed label application machine.

Also, it is to be understood that the label ply in a single-ply, roll-fed expanded content label may be a single ply of material whether coated or uncoated (which may also be referred to, collectively, as a “mono-ply”), a so-called clear protective laminate construction, or any laminated, combined ply, or co-extruded construction, all of which would have an overall characteristic of a single material ply.

More particularly in the example of FIG. 1, web 10—comprising labels 100—includes label ply 102 and break paths 104. As will be described below and as shown in phantom lines in the drawing, lengthwise dimensions of each label 100 will be defined by opposing ends E1 and E2 that will result from cuts made in web 10 by a label application machine. In FIGS. 1a and 1b, the example of a portion of web 10 is illustrated in cross-section as taken along lines a-a and b-b, respectively, in FIG. 1. As aforementioned, and as shown in FIGS. 1a and 1b, in this example ply 102 of web 10 has an overall characteristic of a single material ply and comprises a clear protective laminate construction. Thus in this example, ply 102 includes a base material 110 that may optionally include printed graphics 112 on a top side and a bottom side thereof, and a clear laminate material 120 that could be adhesively joined to base material 110 by an adhesive material 114. Additionally in this example, a bottom side of base material 110 could include a release material 116 that could be selectively deposited thereon. Release material 116 will be further described below regarding application of a single-ply, roll-fed expanded content label to an object to be labeled, and in use of such label.

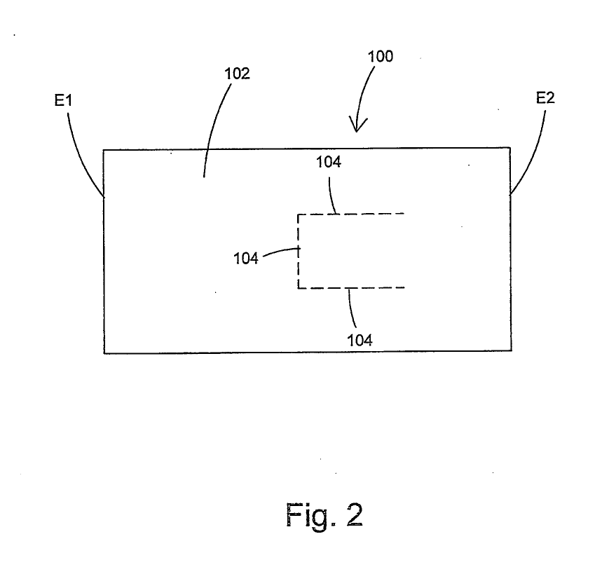

FIG. 2 illustrates an example of a single-ply, roll-fed expanded content label 100, cut from web 10 of FIG. 1. Therein, label 100 includes label ply 102 and break paths 104. As aforementioned, a lengthwise dimension of label 100 could be defined by opposing ends E1 and E2 resulting from cuts made in web 10 by a label application machine.

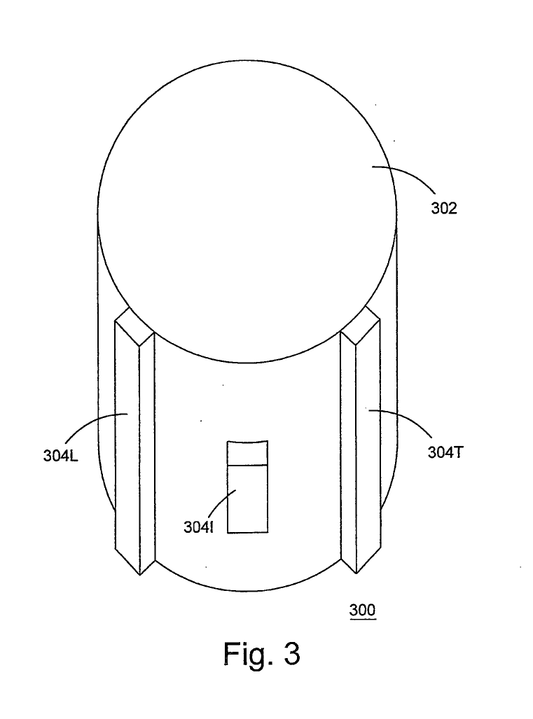

FIG. 3 illustrates an example of a device 300 for applying adhesive material to single-ply, roll-fed expanded content labels. Device 300 could comprise a vacuum drum 302, including a leading edge adhesive material application pad 304L, a trailing edge adhesive material application pad 304T, and an intermediate adhesive material application pad 304I.

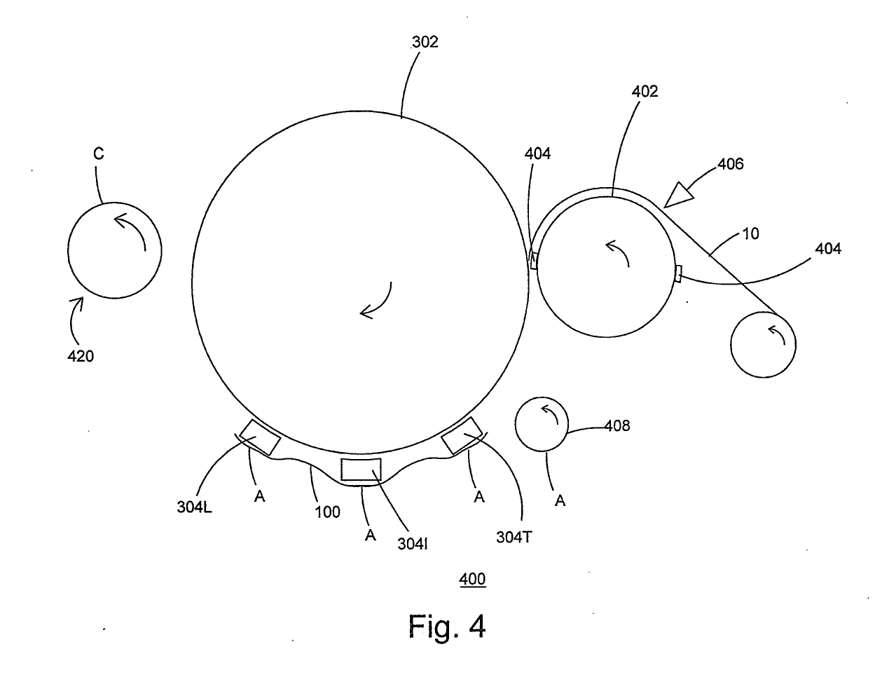

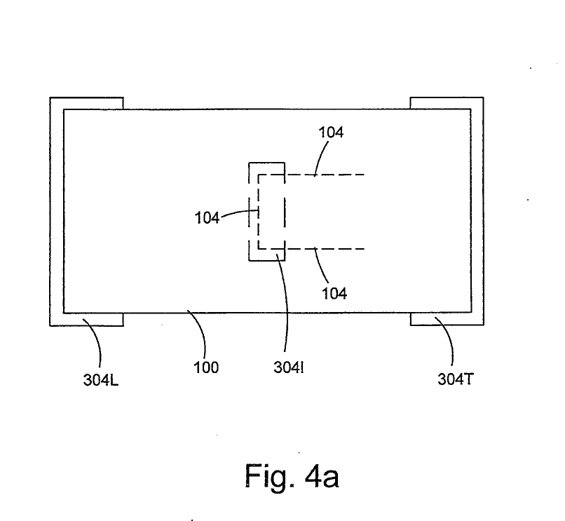

FIG. 4 illustrates an example of a method for applying single-ply, roll-fed expanded content labels to objects to be labeled such as a container C, utilizing the example of a device shown in FIG. 3. Thus in the example of FIG. 4, a label application machine 400, utilizing device 300, could comprise vacuum drum 302 that in turn could include leading edge adhesive material application pad 304L, trailing edge adhesive material application pad 304T, and intermediate adhesive material application pad 304I. Machine 400 also could comprise a cutting drum or mandrel 402 that could include cutting anvils 404 which are used in cooperation with a cutting knife 406 as will be described, and a roller 408 for application of a point-of-application adhesive material (A) to each single-ply, roll-fed expanded content label that is to be applied to objects to be labeled such as container C. Machine 400 further could comprise an application spindle 420 that rotates an object to be labeled (e.g., container C) about its longitudinal axis—or that simply allows the object to be rotated—so that a single-ply, roll-fed expanded content label (e.g., label 100) may be adhered to the object by way of point-of-application adhesive material (A) as the label departs from drum 302 in the method of machine 400.

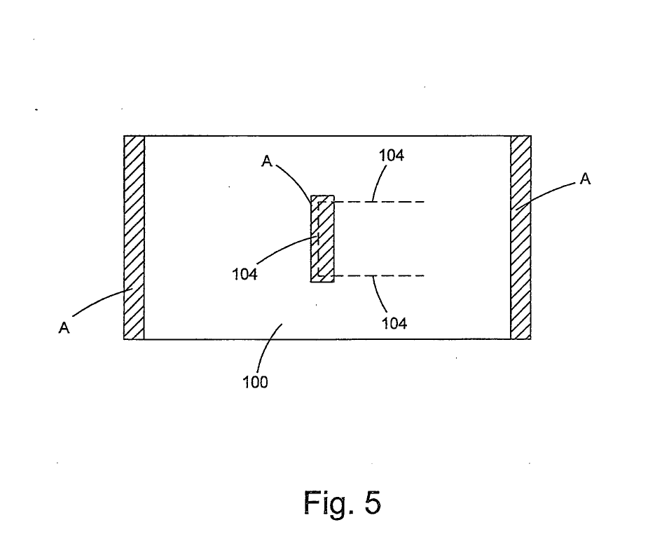

In the example of FIGS. 4 and 4a, a single-ply, roll-fed expanded content label web (e.g., web 10) could be introduced to label application machine 400 at cutting drum or mandrel 402, whereupon it could be sequentially cut into individual labels (e.g., label 100 as shown in FIG. 2) by way of anvils 404 and knife 406. Upon reaching vacuum drum 302, a single-ply, roll-fed expanded content label such as, e.g., label 100 could receive point-of-application adhesive material (A) by way of roller 408 working in cooperation with pads 304L, 304I, and 304T. In this regard, FIG. 5 illustrates the example of a single-ply, roll-fed expanded content label 100 of FIGS. 4 and 4a, having received point-of-application adhesive material (A) on its back surface by way of roller 408 working in cooperation with pads 304L, 304I, and 304T.

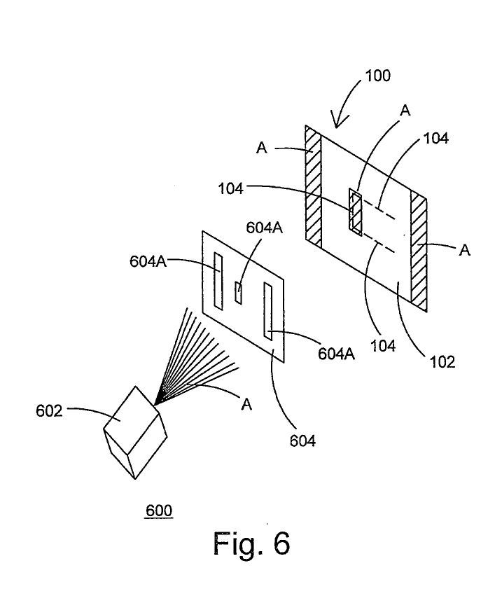

FIG. 6 illustrates another example of a device 600 for applying adhesive material on back surfaces of single-ply, roll-fed expanded content labels. Device 600 could comprise a point-of-application adhesive material sprayer 602 and a spray template or shield 604 including at least one aperture 604A to direct point-of-application adhesive material (A) onto desired areas of single-ply, roll-fed expanded content labels such as, e.g., label 100. It is to be appreciated and understood that device 600 could be used, e.g., as an alternative to device 300, and that any numbers and combinations of devices for applying adhesive material to single-ply, roll-fed expanded content labels—such as, e.g., devices 300 and 600—could be employed as may be desired in a particular embodiment of a device and method for applying single-ply, roll-fed expanded content labels to objects.

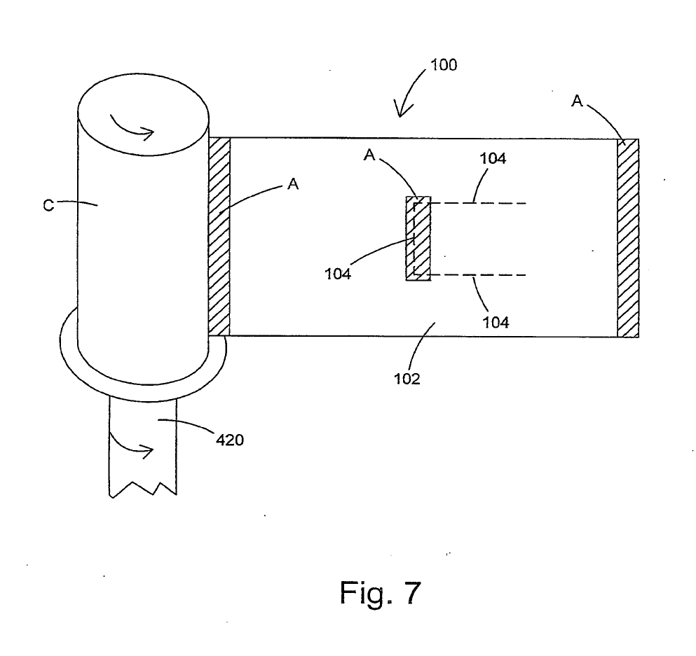

FIG. 7 depicts the example of label 100 as being adhered to container C (application spindle 420 of the method of FIG. 4 is depicted in isolation from machine 400, for clarity). As shown in the drawing, a single-ply, roll-fed expanded content label such as label 100 could be adhered to an object such as container C with point-of-application adhesive material (A) at the leading, intermediate, and trailing portions thereof. In this regard, application of the label (e.g., label 100) to the object (e.g., container C), may be accomplished by way of subsequent encircling of the object by the label as the object rotates on spindle 420. Although not illustrated, but as known in the roll-fed label art, it is usual and customary to allow or provide for some slight overlap of the label when adhered to the object to be labeled.

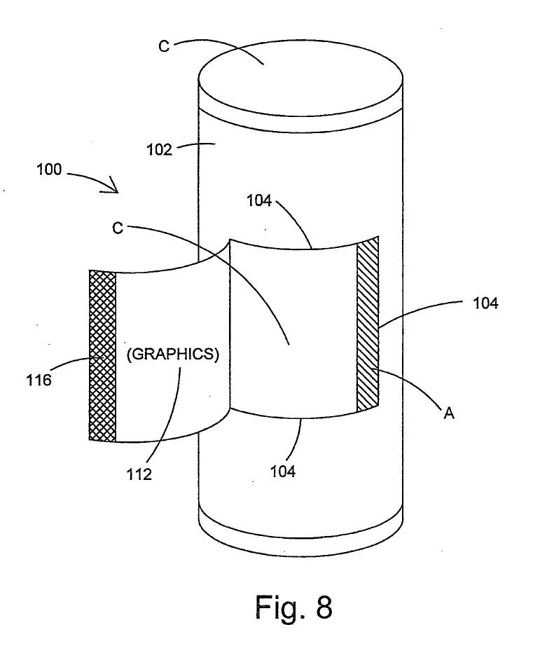

FIG. 8 depicts the example of label 100 as having been adhered to container C and subsequently opened or accessed by, e.g., a consumer or end-user. In this regard, a consumer or end-user could manipulate ply 102 of label 100 so that a portion of ply 102 defined by break paths 104 in ply 102 could be separated or lifted away non-destructively from container C by way of release material 116. In this regard, release material 116 on ply 102 could allow for separation of that portion of ply 102 from point-of-application adhesive material (A) provided by, e.g. pad 304I of device 300. Such separating or lifting of ply 102 could then reveal, as desired, any optional graphics 112 that may have been provided on ply 102 (as shown, e.g., in FIG. 1a) along with any optional graphics that may have been provided directly on a surface of container C. The consumer or end-user could then, for example, manipulate that portion of ply 102 defined by break paths 104 to close or reseal label 100 by way of a releasable and resealable interaction of release material 116 with point-of-application adhesive material (A) as aforedescribed. As used throughout this disclosure, the term “manipulate” could include, but not be limited to, acts of opening or accessing, and closing or resealing, the label—or even removal of the opened portion in coupon-like fashion—to access information or graphics without unintended destruction of the label ply or the object to which the label has been applied. Also, although examples of break paths are illustrated as being substantially within an interior of label 100, it is to be appreciated and understood that an embodiment of a single-ply, roll-fed expanded content label could ultimately be constructed with break paths positioned to enable the label to be fully openable or accessible to a point where the label at its end is adhered to the container and then resealed by re-encircling the openable or accessible portion around the container; and that therefore a relatively large amount of available surface area (e.g., for desired graphics) could be provided by such a construction. Also, it is to be appreciated and understood that in a particular embodiment of a single-ply, roll-fed expanded content label, a plurality of separate regions therein as defined by a plurality of separate break path regions could be provided for, e.g., separate accommodation and presentation of multi-lingual information. Additionally, it is to be appreciated and understood that in a particular embodiment of a single-ply, roll-fed expanded content label, break paths could be omitted entirely. In such a construction, selective depositions of adhesive and release materials could enable any portion of the label ply to be non-destructively separated from or lifted off from an object to which the label has been applied. Thus, in such a construction, a selected portion of a bottom surface of the label could be revealed to an end user or consumer.

It is to be appreciated and understood generally, that any selected portion or portions of a single-ply, roll-fed expanded content label could be capable of being non-destructively separated from or lifted off from an object to which the label has been applied, from an interior portion of the label toward any end thereof or vice-versa; and that any such portion or portions could be provided to open and close in any desired direction. Thus, any areas or regions of the label defined by that label's height, length, or any combinations of its parameters, could serve as the portion or portions that are capable of being non-destructively separated from or lifted off from an object to which the label has been applied.

It is additionally to be appreciated and understood that, although not illustrated herein, a single-ply, roll-fed expanded content label could be constructed in which no release material is present. In such an embodiment, the label may, for example, utilize a ply material that inherently has selected regions having a property of a release material to enable non-destructive manipulation of the label. Furthermore, a point-of-application adhesive material could be utilized that has a sufficiently low aggressiveness (e.g., a removable, low-tack, or “peelable” adhesive material) to enable non-destructive manipulation of the label.

It further is to be appreciated and understood that materials which permit non-destructive manipulation of the labels, that are employed to provide various embodiments of a single-ply, roll-fed expanded content label, may take any desired form, pattern, or configuration, whether fully or partially across the label ply. Although not illustrated, it is to be understood that the materials which permit non-destructive manipulation of the labels could be provided on a front surface as well as a back surface of a label ply, or both.

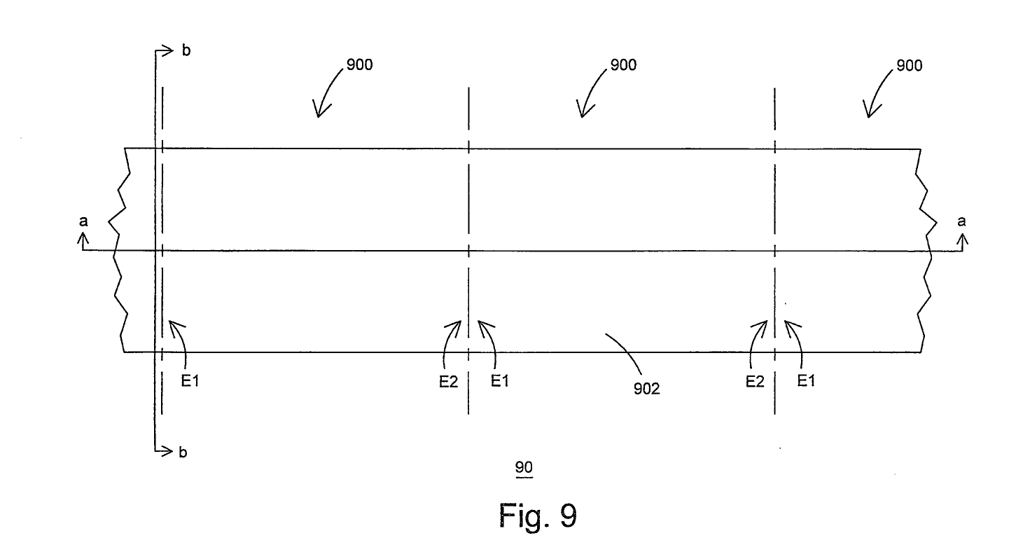

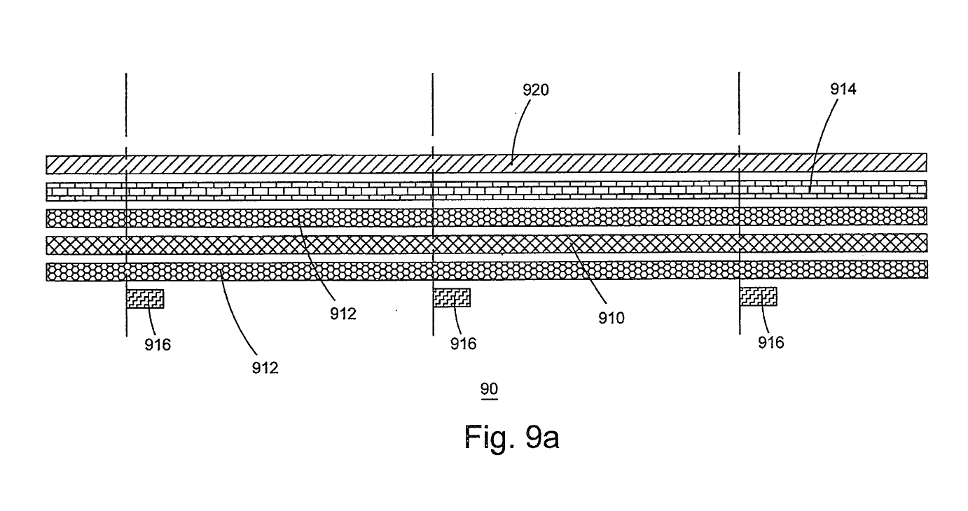

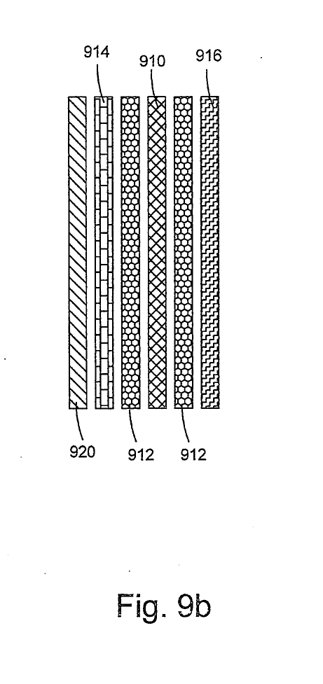

Another example of a portion of a label web 90 for single-ply, roll-fed expanded content labels 900 is illustrated in FIGS. 9, 9a, and 9b. Therein, label web 90, comprising individual labels 900, could include a label ply 902. Ply 902 could be similar, or even identical, in its composition to the example of ply 102 as aforedescribed relative to, e.g., dimensions, graphic images, and coatings, and also relative to “mono-ply”, laminate, combined ply, or co-extruded constructions having an overall characteristic of a single material ply.

More particularly in the example of FIG. 9, as shown in phantom lines in the drawing, lengthwise dimensions of each label 900 will be defined by opposing ends E1 and E2 that will result from cuts made in web 90 by a label application machine. In FIGS. 9a and 9b, the example of a portion of web 90 is illustrated in cross-section as taken along lines a-a and b-b, respectively, in FIG. 9. As shown in FIGS. 9a and 9b, in this example ply 902 of web 90 has an overall characteristic of a single material ply and comprises a clear protective laminate construction. Thus in this example, ply 902 includes a base material 910 that may optionally include printed graphics 912 on a top side and a bottom side thereof, and a clear laminate material 920 that could be adhesively joined to base material 910 by an adhesive material 914. Additionally in this example, a bottom side of base material 910 could include a release material 916 that could be selectively deposited thereon.

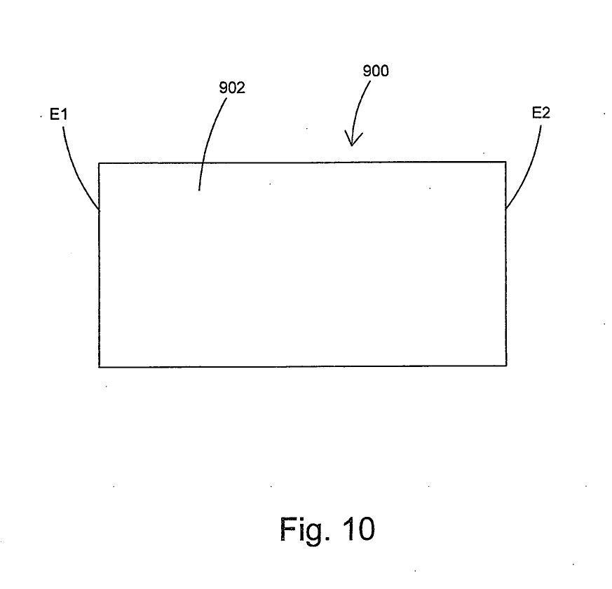

FIG. 10 illustrates an example of a single-ply, roll-fed expanded content label 900, cut from web 90 of FIG. 9. Therein, label 900 includes label ply 902. As aforementioned, a lengthwise dimension of label 900 could be defined by opposing ends E1 and E2 resulting from cuts made in web 90 by a label application machine.

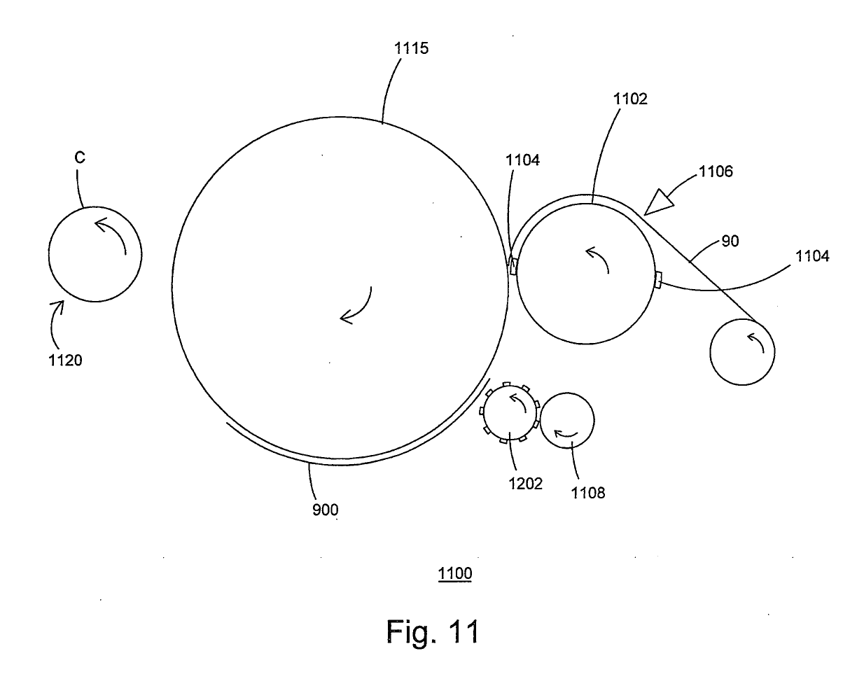

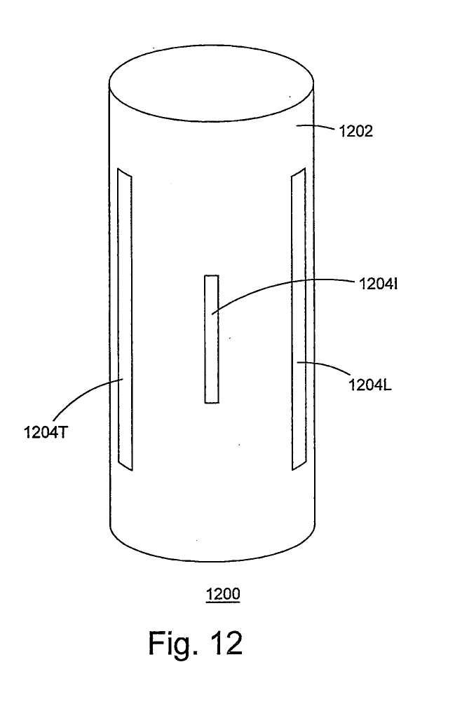

FIGS. 11 and 12 illustrate another example of a method for applying single-ply, roll-fed expanded content labels to objects to be labeled such as a container C, and a device 1200 for applying adhesive material to single-ply, roll-fed expanded content labels, respectively. Thus in the example of FIGS. 11 and 12, a label application machine 1100, utilizing device 1200, could comprise roller 1202 that in turn could include a repeating sequence of adhesive material application pads such as leading edge adhesive material application pad 1204L, trailing edge adhesive material application pad 1204T, and intermediate adhesive material application pad 1204I. Machine 1100 could also comprise a cutting drum or mandrel 1102 that could include cutting anvils 1104 which are used in cooperation with a cutting knife 1106, and a roller 1108 for supplying point-of-application adhesive material (A) to roller 1202. Machine 1100 further could comprise a vacuum drum 1115 and an application spindle 1120 that rotates an object to be labeled (e.g., container C) about its longitudinal axis—or that simply allows the object to be rotated—so that a single-ply, roll-fed expanded content label (e.g., label 900) may be adhered to the object by way of point-of-application adhesive material (A) as the label departs from vacuum drum 1115 in the method of machine 1100.

In the example of FIGS. 11 and 12, a single-ply, roll-fed expanded content label web (e.g., web 90) could be introduced to label application machine 1100 at cutting drum or mandrel 1102, whereupon it could be sequentially cut into individual labels (e.g., label 900) by way of anvils 1104 and knife 1106. Upon reaching vacuum drum 1115, a single-ply, roll-fed expanded content label such as, e.g., label 900 could receive point-of-application adhesive material (A) by way of roller 1108 working in cooperation with pads 1204L, 1204I, and 1204T of roller 1202.

Regarding construction of a particular embodiment of a single-ply, roll-fed expanded content label, the label ply could preferably be any commercially available web-like material that is capable of use in an in-line printing and converting process. Such a material could be, for example, polypropylene as is commercially available from AET Films of Terre Haute, Indiana, in the U.S. As used herein, the term “web-like material” is intended to include any suitable label material, including paper, film, polypropylene, polyethylene, polyester, polyvinylchloride, polystyrene, foil, and ethylene vinyl acetate. The ply selectively could comprise a so-called “shrink promoting” material to conform to several or irregular curvatures of an object to which the label is applied. Such a material could be, but not limited to, that which exhibits desired stretch and shrinkage characteristics such as are commercially available and known to those skilled in the art. Also material that permits non-destructive manipulation of a label that may be utilized in construction of a particular embodiment of a single-ply, roll-fed expanded content label such as, e.g., release material 116, could preferably be a coating chosen from a group comprising water-based, solvent-based, UV/EB, cold seal, heat seal, cohesive, and hot melt coatings as are commercially available. The material that permits non-destructive manipulation of the label is preferably chosen with respect to, and in combination with, the point-of-application adhesive material to provide ease of opening, resealability, and other manipulation of the label.

Generally, it is to be appreciated and understood that several of those embodiments of a single-ply, roll-fed expanded content label described herein could have particular utility in labeling objects or containers that have a regular shape, which may be cylindrical, or another shape, which is of relatively constant outer dimension from top to bottom. Other objects or containers, however, may have substantially non-constant outer dimensions such as, e.g., coved or rounded top and bottom shoulder-type tapers which, it is to be understood, also could be accommodated by a particular embodiment of a single-ply, roll-fed expanded content label. Furthermore, it is to be understood that any embodiment of a single-ply, roll-fed expanded content label could be applied by so-called “cut-and-stack” labeling equipment to an object of interest to be labeled.

It is also to be appreciated and understood that a device for applying adhesive material to single-ply, roll-fed expanded content labels contemplated herein make take any form, dimension, configuration, composition, and construction, regardless of a particular embodiment such as those examples shown and described herein. Thus, a device for applying adhesive material to single-ply, roll-fed expanded content labels contemplated herein could comprise, generally, components for applying adhesive material to (i) leading and trailing edge portions of a label along with (ii) any portion or portions of the label that is or are between, or intermediate to, its leading and trailing edges. Such a device could further comprise a plurality of adhesive material application components having any desired pattern, for a patterned application of adhesive material.

Although examples herein of devices for applying adhesive material to single-ply, roll-fed expanded content labels and associated examples herein of methods for applying the labels to objects to be labeled have included descriptions of vacuum drums, it is to be appreciated and understood that any suitable alternatives, or additions, to vacuum drums such as gripping means, whether mechanical pneumatic, electric, or otherwise, may be employed in a particular method for applying the labels to objects.

It is to be appreciated and understood, although not described herein, that devices and methods for applying single-ply, roll-fed expanded content labels to objects to be labeled could include a plurality of roller-type devices having any combinations of adhesive material application pads. Thus, for example, a particular device and method could include two roller-type devices with one roller-type device having two adhesive material application pads (e.g., pads 1204T and 1204I) and the other roller-type device having one adhesive material application pad (e.g., pad 1204L). Also, it is to be appreciated and understood, although not described herein, that devices and methods for applying single-ply, roll-fed expanded content labels to objects to be labeled could be suitably modified to provide adhesive material directly on an object to be labeled.

While this disclosure has been particularly shown and described with reference to accompanying figures, it will be understood, however, that modifications are possible. It should be appreciated that various components described herein may be substituted for other suitable components for achieving desired results, or that various accessories may be added thereto.

Also, the depictions of various containers in the figures are only exemplary and not meant to be limiting.

Additionally, it is to be understood that although some components are depicted as being separated or spaced apart from each other for clarity in the drawings (e.g., label components in FIG. 1a and machine components in FIG. 4), such components could be in closer proximity to, or even in physical contact with, each other.

It is to be understood that any suitable alternatives may be employed to provide a single-ply, roll-fed expanded content label device and method.

Lastly, the choice of compositions, sizes, and strengths of various components described herein are to be selected depending upon intended use.

Accordingly, these and other various changes or modifications in form and detail may be made to a single-ply, roll-fed expanded content label application device and method, without departing from the true spirit and scope thereof.

1. A device for applying adhesive material to single-ply, roll-fed expanded content labels, comprising: a leading edge adhesive material application pad, a trailing edge adhesive material application pad, and an intermediate adhesive material application pad.

2. A method for applying single-ply, roll-fed expanded content labels to objects to be labeled, comprising the device of claim 1.

3. A device for applying adhesive material to single-ply, roll-fed expanded content labels, comprising: a point-of-application adhesive material sprayer for depositing point-of-application adhesive material onto desired areas of single-ply, roll-fed expanded content labels.

4. The device for applying adhesive material to single-ply, roll-fed expanded content labels of claim 3, further comprising a spray template including at least one aperture, to direct the point-of-application adhesive material onto desired areas of the single-ply, roll-fed expanded content labels.
